(19) United States
(12) Patent Application Publication
(10) Pub. No.: US 2004/0002371 A1
(43) Pub. Date: Jan. 1, 2004

(54) Method and apparatus for automated system for validating a set of collectible lottery tickets

(76) Inventors: Claude Paquin, San Antonio, TX (US); Zhanbo Yang, San Antonio, TX (US)

Correspondence Address: WATOV & KIPNES, P.C., P.O. Box 247, Princeton Junction, NJ, 08550, US

(21) Appl. No.: 10/253,258

(22) Filed: Sep. 24, 2002

Related U.S. Application Data
(60) Provisional application No. 60/326,261, filed on Oct. 1, 2001.

(51) Int. Cl. G06F 17/00; G06F 19/00

(52) U.S. Cl. 463/17

(57) ABSTRACT

The invention relates to an automated system for validating a set of collectible lottery tickets includes a plurality of retailer computer terminals configured to print and issue the lottery tickets, and to validate a winning combination of the tickets by scanning them, and submitting the scanned data to a remotely located central validation computer system programmed to compare the scanned ticket data with a winners list in a central databank, and thereafter communicate the results to the associated retailer.

The present invention relates generally to methods and systems for validating lottery tickets, and more particularly for validating a set of collectible lottery tickets.

A typical state or government run lottery game requires players to purchase single tickets, any one of which may be a winner. Tickets are purchased from licensed retailers, who are provided a computerized terminal for both issuing tickets, and validating single tickets to determine if a ticket is a winner.

Sponsors of lottery games are constantly developing new forms of lottery games. Recently, games that require a collection of interdependent tickets to be a winner for the same game, are actively being developed. Also, under development are games that provide a winner for a collection of tickets from different games, where an individual ticket also may or may not be a winner for a game it is directly associated with. As a result, single ticket validation methods and systems are not applicable for use in validating tickets that are associated with a collection of interdependent tickets from either a single game or different games. Accordingly, new methods and systems must be developed for validating collectible lottery tickets.

### SUMMARY OF THE INVENTION

The invention relates to a system and method for validating a set of collectible lottery tickets. The system utilizes at least two lottery tickets each including a collectable part having associated verification indicia. A retailer computer terminal is located at a retailer location. The retailer computer terminal is operable to at least temporarily store the verification indicia from the collectible parts. A computerized central validation system is located remotely from the retailer location. The computerized central validation system includes a database containing validation data.

The retailer computer terminal is operable to communicate the verification indicia from the retailer computer terminal to the central validation system. The central validation system is operable to perform validation of the at least two collectible parts to determine whether the at least two collectible parts are a winning combination based on the verification indicia and the validation data thereby generating validation results. The central validation system is then operable to communicate the validation results to the retailer computer terminal.

In a preferred aspect of the invention, a winning combination requires a specific combination of two collectable parts. In another preferred aspect of the invention, a winning combination requires a specific combination of three collectable parts. In yet another preferred aspect of the invention, the associated verification indicia is a bar code.

In another preferred aspect of the invention, the retailer computer terminal includes at least one bar code scanner operable to read the bar codes associated with the collectable parts. In another preferred aspect of the invention, the collectible part has an associated game number, group number, VIRN and check digit number and wherein the validation process includes verifying that the collectible portions have the proper game number, group number, VIRN and check digit number. In another preferred aspect of the invention, each lottery ticket has an instant win part and a collectable part.

In another preferred aspect of the invention, the instant win part and collectable part each have an associated ticket number. In another preferred aspect of the invention, the collectable part ticket number is an integer multiple of the instant win part ticket number.

A technical effect of the invention is to provide an integrated system with a scanning device and associated computer system operable to scan a collection of tickets and perform automated validation of the collection. In this regard, the invention provides a unique hardware and software configuration operable to improve the speed, accuracy and security associated with validation of a collection of tickets as disclosed herein.

### BRIEF DESCRIPTION OF THE DRAWINGS

FIG. 1 is a block schematic diagram of a system for one embodiment of the invention;

FIG. 2 is a computer screen display showing the data organization for one embodiment of the invention;

FIGS. 3 and 4 show computer screen display examples of information provided in validating one or more tickets in accordance with the invention;

FIGS. 5 and 6 show pictorial examples of a lottery ticket in accordance with the invention;

FIG. 7 is a pictorial view showing an exemplary game board in accordance with the invention;

FIGS. 8 and 9 are pictorial views showing exemplary prize legends in accordance with the invention;

FIG. 10 shows a block diagram showing a basic functional model of an exemplary CVS in accordance with the invention;

FIG. 11 is a pictorial view showing an exemplary Login screen from an exemplary Collection Validation System in accordance with the invention;

FIG. 12 is an exemplary flow chart outlining the login process in accordance with the invention;

FIG. 13 is a pictorial view showing the general relationship between various exemplary CVS system screens;

FIG. 14 shows an exemplary validation screen in validating one or more tickets in accordance with the invention;

FIGS. 15-17 are flow charts generally outlining the validation process in accordance with the invention;

FIG. 18 shows an exemplary validation screen in validating one or more tickets in accordance with the invention;

FIG. 19 shows an exemplary validation screen in validating one or more tickets in accordance with the invention;

FIG. 20 shows an exemplary validation screen in validating one or more tickets in accordance with the invention;

FIG. 21 shows an exemplary validation screen in validating one or more tickets in accordance with the invention;

FIG. 22 is a flow chart showing basic group maintenance tasks in accordance with the invention;

FIG. 23 is an exemplary add new games screen in accordance with the invention;

FIG. 24 is an exemplary add new games screen in accordance with the invention;

FIG. 25 is an exemplary add new games screen in accordance with the invention;

FIG. 26 is an exemplary add new games screen in accordance with the invention;

FIG. 27 is an exemplary group maintenance screen in accordance with the invention; and

FIG. 28 is an exemplary validation information screen in accordance with the invention.

### DETAILED DESCRIPTION OF THE INVENTION

The invention generally relates to system and method automated validation of a set of collectible lottery tickets. In one embodiment, the invention includes a retailer computer terminal located a retailer location. The retailer computer terminal allows a retailer to issue and sell lottery tickets, and to automatically validate both single, and/or a collection of interdependent tickets from either a single game or different games. The retailer computer terminal generally includes a central processing unit (CPU), such as a personal computer, a computer monitor or display, and a scanner for scanning lottery tickets coded with some form of machine readable indicia or verification indicia (e.g., bar code).

The CPU of the retailer computer terminal is programmed to automatically receive the bar coded data, and communicate with a remotely located computerized control validation system programmed to receive and compare the scanned data with a winners list and communicate validation results to the retailer computer terminal (i.e., whether or not the ticket is validated as a winner). Communication between the retailer computer terminal and the remotely located computerized control validation system can be carried out by a myriad of devices including but not limited to dial-up modem, cable modem, T1, DSL wireless transmission and the like. Similarly, an unlimited array of data communication protocols can be used to facilitate data communication (e.g., TCP/IP). If the ticket is one of a collection of tickets, the central validation system or CVS (e.g., operated by a state run lottery or a lottery service provider) is programmed to sequentially validate the tickets to advise the retailer whether the collection of tickets is a winning combination.

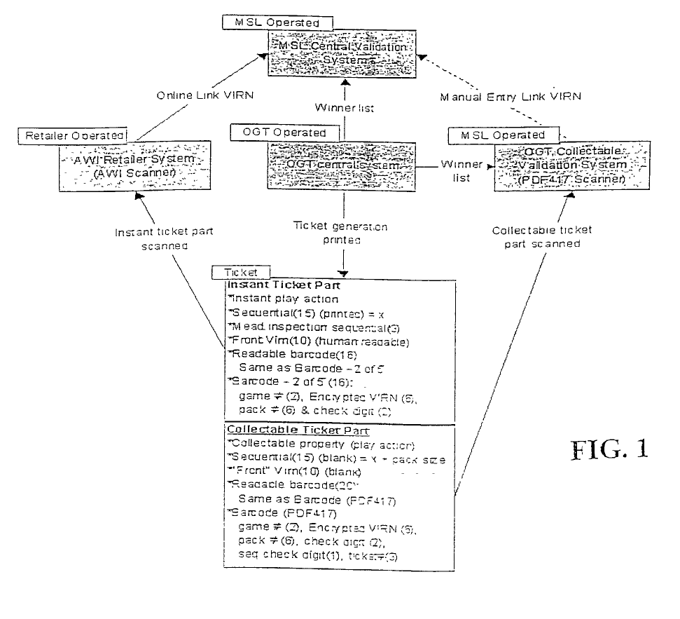

FIG. 1 shows an exemplary block schematic diagram of a system for one embodiment of the invention. In the current example, the system is described in relation to a state run lottery (the Minnesota State Lottery or MSL), a lottery service provider (OGT) and a retailer.

FIG. 1 illustrates allocation of various system resources. In this example, MSL Validation Personnel load validation files, initiate, perform and monitor game validation. OGT performs several functions including software development, data management and quality control functions. For example, OGT Game Software Development programs the games (i.e., generates the computer program code for administration). OGT Data Center is responsible to produce and ship the validation files to the Lottery. OGT Quality Control is responsible for ticket reconstruction. Retailers are responsible for validating the instant tickets on the validation terminal. Other vendors can be utilized to support various aspects system (e.g., hardware/software). In this example, an outside vendor (AWI) is responsible for providing and maintaining the instant ticket validation terminals.

The Lottery Ticket

The lottery ticket preferably includes an instant part (e.g., a typical scratch-off type game) and a collectable part (i.e., requiring the collection of two or more tickets to form a winning combination). Preferably, the Instant and collectable portions of the printed ticket are each assigned 2 different ticket numbers in the MSL central validation file.

Ticket Numbering

For the ticket numbering, consider a quantity of x tickets per book where one ticket is the instant part of the ticket plus its collectable part. The ticket number printed on the instant ticket part will go from 0 to x-1. The ticket number for the collectable portion is optionally printed (e.g., if requested by MSL). Nevertheless, the MSL central validation tiles will contain a sequential number for collectable part of the ticket. The collectable portion of the ticket will be assigned a ticket number ranging from x to 2*x-1. For example, if there are 75 tickets per book (where a physical ticket is the instant and the collectable part), on the validation file the first ticket of the book will be 000 for the instant part and 075 for the collectable part, the second ticket of the book will be 001 for the instant par and 076 for the collectable part, etc. etc.

Collectable Ticket Prize

The prize value of a complete collectable set can be assigned to a single ticket of the collection or divided into any proportion between the tickets of the collectable set. In For example in an implementation of the Monopoly® game, a single property can be designated as the “rare” property. Continuing with this example, the red property collection generally includes Kentucky Avenue, Indiana Avenue and Illinois Avenue. Assume that Illinois Avenue is the rare property, the prize value of this collection could be assigned to this single ticket. The other tickets of this collection would be non-winners in MSL central validation files. Another example with the Monopoly® game would be with the railroad property where any 2 different railroads are needed to win the prize. In this case, the value of the prize could be divide in 2 and assigned to each railroad tickets. It is understood that variations can occur in the division of prize values among various members of a collection without departing from the scope of the invention. Preferably, the CVS will only validate the tickets as winner if the collection is complete.

Void If Removed Number (VIRN)

The VIRN on the collectable portion of the ticket is preferably the same content format as the VIRN in the barcode of the instant portion. Each one will preferably have a different and unique value throughout the game including reorder. The CVS will identify and display for a winning collection, the tickets (items) of the collection that has a value greater than 0$. This will allow MSL to key in their central validation system only the tickets (items) related to a winning collection set that has a value associated to it.

Barcode

The standard MSL barcode (2 of 5 barcode) is preferably used on the instant part of the ticket. In this example, the barcode contain 16 digits (GGVVVVVVPPPPPPCC) where G is game #, V is validation #, P is pack # and C is the check digit. The collectable portion preferably has the same content format but is preferably encoded in a PDF417 barcode. PDF stands for “Portable Data File”. This is generally know in the art as a two-dimensional symbology. A single PDF417 symbol carries up to 1.1 kilobytes of machine-readable data in a relatively small space (often no larger than a standard bar code).

Security

In the VIRN file of the CVS, the VIRN number, is preferably a 10 digit decrypted value corresponding to the 6 digits compress VIRN in the PDF4 17. This will provide the security needed by breaking any link between both VIRNs. The file preferably does not contain the ticket and pack number, which are needed by MSL central validation system to validate a ticket.

System Implementation—Data Model

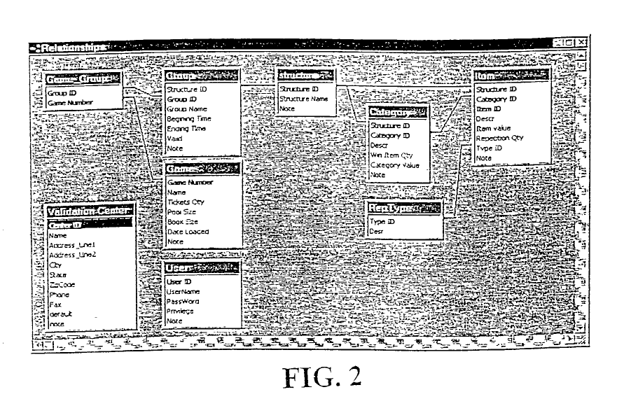

FIG. 2 shows an exemplary data model for implementation of the invention It is understood that other data models could be used without departing from the invention.

In this example, the validation data for the collectable tickets is organized in seven tables. Four tables are preferably used to define the collectable set organization, and the other three tables are preferably used to define how games are organized in groups so that tickets in those games can be validated together. Two other tables are preferably used to hold information about users and validation centers. These tables can be managed my various software packages in this example, the tables are managed with MS-ACCESS® database software.

The term “database” as used herein generally refers to a collection of information stored for later retrieval. Traditional databases are organized into fields, records, and files. A field is a single piece of information; a record is one complete set of fields; and a file is a collection of records. The term “database” is used herein in its broadest sense (i.e., a collection of information) and is not limited to any particular structure or implementation.

An external ASCII file is utilized to store the VIRN table (Game #X VIRN). This file preferably contains the identification of each collectable ticket. The estimated size of this file will be about 11 MB per million tickets.

MS-ACCESS Tables

TABLE 1
Game

| Field | Description |
|---|---|
| Game number | Game number |
| Name | Game name |
| Tickets Qty | Qty of tickets (records) in the collectable |
| | validation file (Game #X VIRN) |
| Pool Size | Qty of tickets in each pool |
| Book Size | Qty of tickets in each book |
| Date Loaded | Date the game was loaded by MSL in the |
| | CVS |
| Note | Any supplemental information associated |
| | with this game. |

TABLE 2
Structure

| Field | Description |
|---|---|
| Structure ID | A unique identifier for each structure |
| Structure Name | A name for each structure |
| Note | Any supplemental information associated |
| | with this structure |

TABLE 3
Group

| Field | Description |
|---|---|
| Structure ID | Link to the Structure Table |
| Group ID | A Unique identifier for each group |
| Group Name | A name for each group |
| Beginning Time | For an active time frame (Not implemented |
| | at this time) |
| Ending Time | For an active time frame (Not implemented |
| | at this time) |
| Valid | A F/T field to mark the Group as |
| | active/inactive. (Not implemented at this |
| | time.) |
| Note | Any supplemental information associated |
| | with this Group |

TABLE 4
Game_Group

| Field | Description |
|---|---|
| Group ID | Link to the Group Table |
| Game Number | Link to the Game Table |

TABLE 5
Category

| Field | Description |
|---|---|
| Structure ID | Link to the Structure Table |
| Category ID | A unique identifier of a set of collectable |
| | Items. |
| Descr | Description of the set of collectable items. |
| | For example for Monopoly ®, the Descr |
| | field for the red property could be <<Red |
| | Property>> |
| Min Item Qty | Quantity of items needed to win the prize |
| | associated to a set of collectable. For |
| | example, for Monopoly ® the Red |
| | Property, the value of this field would be 3. |
| | The 3 different Red Properties are needed |
| | to win the prize. For the railroad, this field |
| | would be 2. 2 different railroad properties |
| | (out of 4) are needed to win a prize with |
| | the railroad. |
| Category value | Prize value associated to a winning |
| | collectable set |
| Note | Any supplemental information associated |
| | with this category |

TABLE 6
Item

| Field | Description |
|---|---|
| Structure ID | Link to the Structure Table |
| Category ID | A unique identifier of a set of collectable |
| | Items. |
| Item ID | Identification of an item of a set of |
| | collectable. For example for Monopoly ®, |
| | the Item ID Field for Indiana Avenue of |
| | the red property could be <<In>> |
| Descr | Description of the item of a set of |
| | collectable. For example for Monopoly ®, |
| | the Descr field for Indiana Avenue could |
| | be <<Indiana Avenue>> |
| Item Value | Value associated to a specific item of a |
| | collection. The sum of the Item Value of a |
| | winning collection should be equal to the |
| | collection value field in the collection |
| | categ table. |
| Repetition Qty | Quantity of time (lain, Max or Exactly |
| | refer to Repetition Type field) the current |
| | item can be used in a collection. This field |
| | value will be 1 for all item of the |
| | Monopoly ® game. But for example, if to |
| | have 2 of the same railroad property would |
| | be valid to make a winner instead to be |
| | mandatory to have to different railroad |
| | properties than this field would have a |
| | value of 2 and the Repetition Type field |
| | would have a value of “Max”. |
| Type ID | The Repetition Qty field can be a |
| | Maximum, a Minimum or an exact |
| | quantity of the current item to have to |
| | create a winning collectable set. |
| Note | Any supplemental information associated |
| | with this item |

TABLE 7
RepType

| Field | Description |
|---|---|
| Type ID | A unique identifier for each repetition type |
| Desc | Description of the repetition types (min, |
| | max, exact) |

TABLE 8
Validation Center

| Field | Description |
|---|---|
| Center ID | A unique identifier or each Regional |
| | Validation Center |
| Name | The name of the validation center. |
| Address_line 1 | Address |
| Address_line 2 | Address |
| City | City |
| State | State |
| Zipcode | Zipcode |
| Phone | Phone number |
| Fax | Fax number |
| Default | A T/F field to mark the center as the |
| | default center |
| Note | Any supplemental information associated |
| | with this center |

Constructing database queries targeting specific information contained in the exemplary data model disclosed above is readily apparent to those skilled in the art.

VIRN file format

The VIRN file preferably contains all of the collectable ticket VIRNs but not the VIRNs of the instant part. The name of the file preferably changed with the game number (e.g., in the following format—Game # VIRN). The VIRN file preferably also includes a Category ID. This is an identification of a set of collectable items. For example for Monopoly®, the Category ID field for the red property could be <<Re>> before encryption. The VIRN file preferably also includes an Item ID. This is an identification of an item of a set of collectable. For example for Monopoly®, the Item ID field for Indiana Avenue of the red property could be <<In>> before encryption.

Process Model

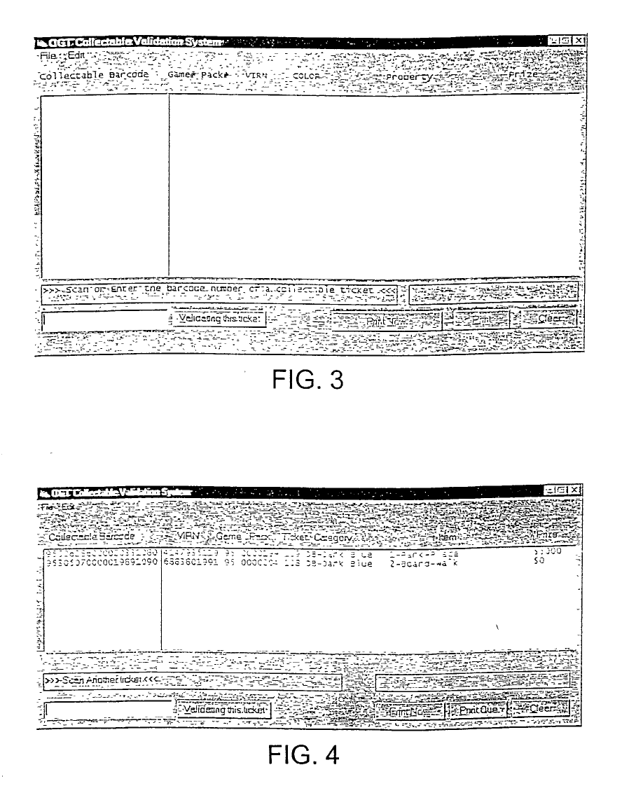

FIG. 3 shows a computer screen display example of information provided in validating one or more tickets in accordance with the invention. The validation screen or main screen prompts the user to scan the barcode(s) on the collectable tickets or enter the value(s) manually. The system is preferably operable to display the collectable barcode, Game#, Pack#, Virn, Color and Property (as discussed above). The system will then verify whether the collection is valid. Assuming the collection is valid, a message is displayed to the user confirming that the collection is valid. In this event, the prize value is preferably displayed in the Prize field. Then the system then supplies the information to key in the MSL central system (not shown in this example).

FIG. 4 shows an example in which two collectable parts have been scanned into the system. The system has verified that all of the members of the collectable set are present (in this case two group collectable tickets). The system has also verified that the prize associated with this collectable set is $5000.

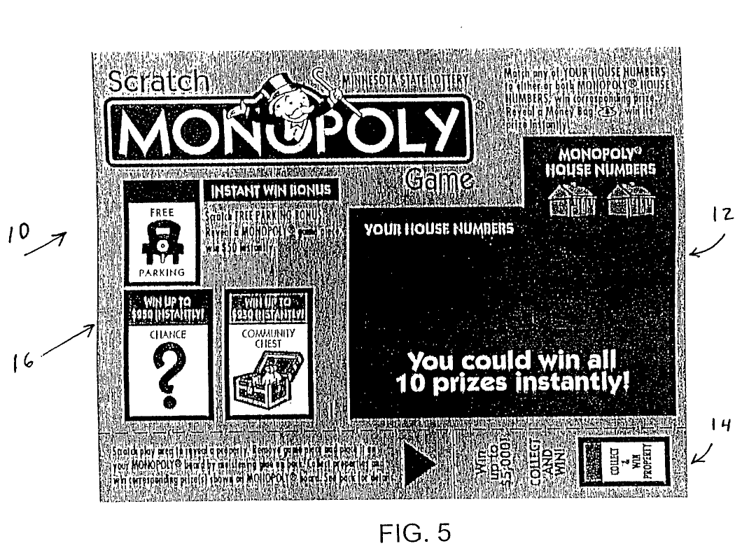

FIG. 5 shows the face of an exemplary ticket 10. The ticket has an instant part 12 and a collectable part 14. The ticket also includes various other information such as a bonus portion 16, instructions for game play and the like.

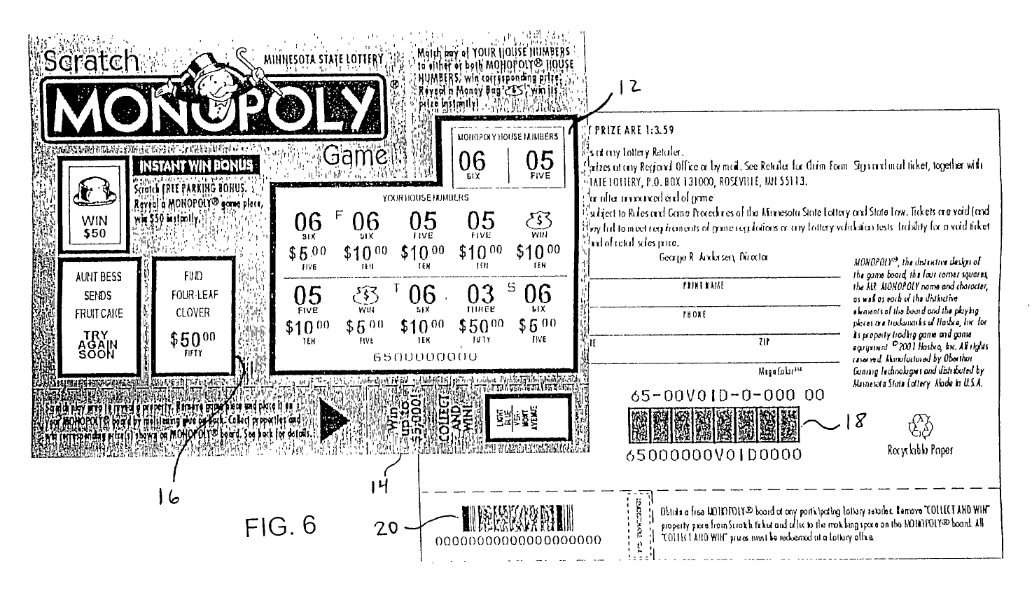

FIG. 6 shows an exemplary ticket in accordance with FIG. 5 having the various scratch-off portions removed. In this example, the instant part as well as the bonus part contained winning indicia or combinations of indicia. The game play and administration of scratch-off or instant win tickets are well known in the art. It is understood that a myriad of different games or themes could be utilized in conjunction with the invention. For example, the invention could utilize a playing card based theme. In such an example, the game would utilize collectable pieces with associated playing card indicia. The goal would then be to collect various hands such as four of a kind and the like.

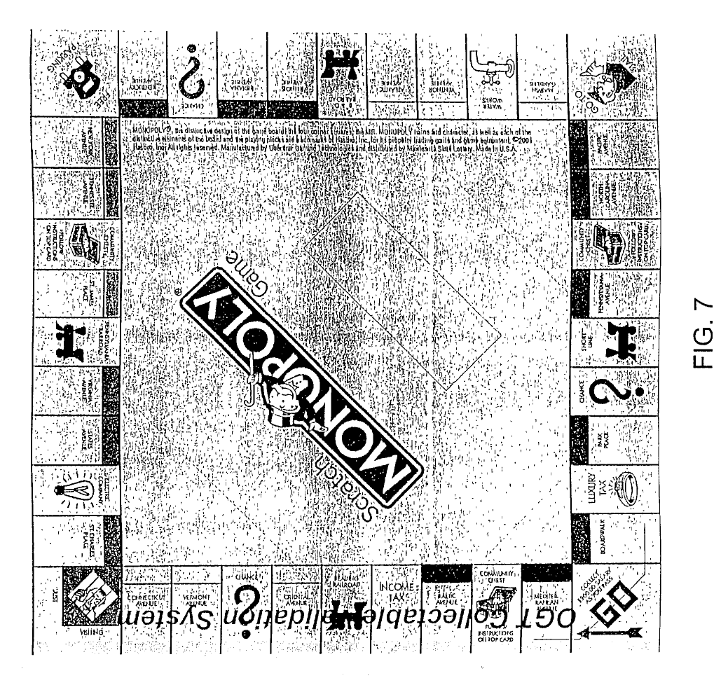

FIG. 6 also shows the rear face of the ticket 10. The rear face also includes a VIRN 18 (located on the instant part 12) and a bar code 20 located on the collectable portion as discussed above. FIG. 7 shows an exemplary game board in accordance with the invention. The game board generally illustrates the combinations of various collectable parts in accordance with a typical Monopoly® game.

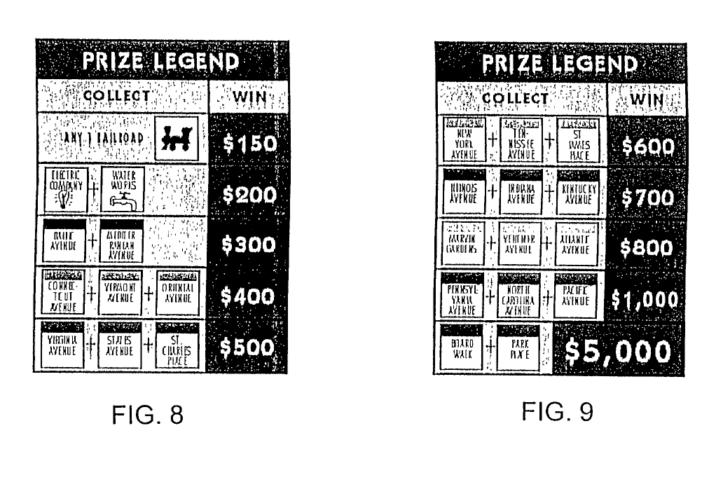

FIGS. 8 and 9 illustrate exemplary prize legends in accordance with the invention. In this example, the top-winning prize for the collectable portion of the game is obtained for the collectable set of Boardwalk and Park Place. In this event, the ticket holder receives $5000. The prizes descend in value based on the particular set collected. In this example, any railroad property instantly wins $150. It is understood that a multitude of prize values and combinations can be utilized without departing from the scope of the invention.

Exemplary CVS Implementation

Based on the description above, it is readily apparent how the invention is generally configured and operated. The invention generally includes a Collectibles Validation System (CVS). The CVS is utilized to validate a collectible part or portion of an instant lottery ticket. A database is preferably used to store the information required to validate the multiple collectible parts that are accumulated and ultimately redeemed by the lottery players. The system also provides utilities to perform relevant and essential database maintenance tasks.

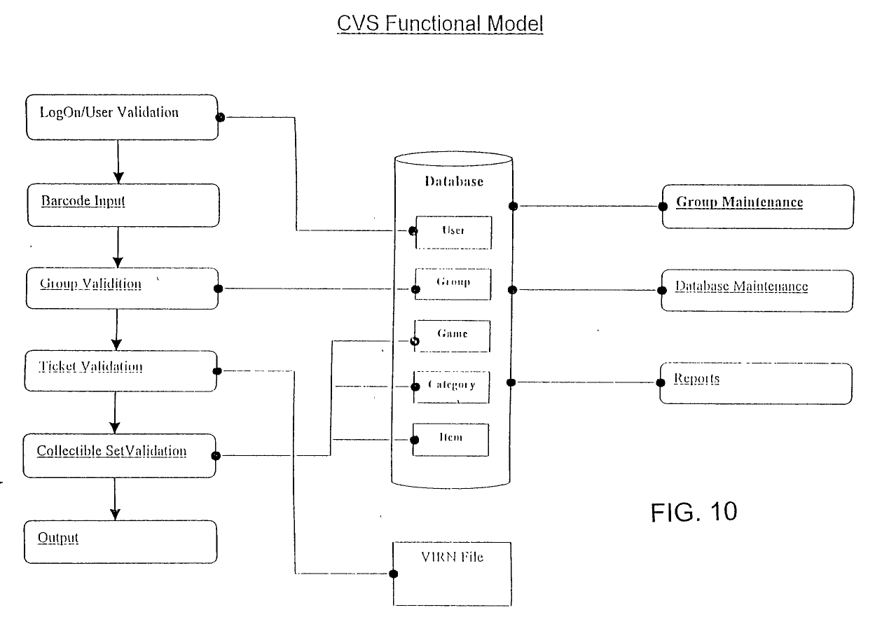

FIG. 10 shows a basic functional model of an exemplary CVS. The database generally stores information relating to the various CVS users, groups, games, categories and items as discussed in more detail below. The CVS also includes software operable to facilitate user login, barcode input, group validation, ticket validation and collectable set validation. Various maintenance and reporting functions are also provided.

Exemplary System Hardware

A typical personal computer can be used in implementing the CVS. For example:

A personal computer and with associated memory, display, keyboard, mouse, storage devices and operating system (e.g., Microsoft Windows 95 and higher or Windows NT). The PC does not need to be dedicated to the CVS.

CD-ROM drive. (Use to load the software and relevant tiles.)

A scanner (e.g., a bar code scanner for PDF417—used to read the barcode associated with the various collectible part(s))

Hard Disk Storage Requirements:

17 MB for the CVS software after installation;

90 NIB estimated maximum for the validation files.

15 MB for user documentation;

In a typical configuration, the maximum total space requirement is about 122 MB.

Configuration and operation of a personal computer with an associated bar code scanner, the loading of software (operating system, drivers, applications) in accordance with the disclosure herein is well within the scope of a person skilled in the art.

Exemplary System Software

The system software preferably includes a setup program that handles the installation process. It is understood that the system software can include several files containing compressed object code and the like (e.g., one or more “cab” files) as well as various support files (e.g., dll files and the like). The installation of a typical Microsoft Windows application is well within the grasp of those skilled in the art.

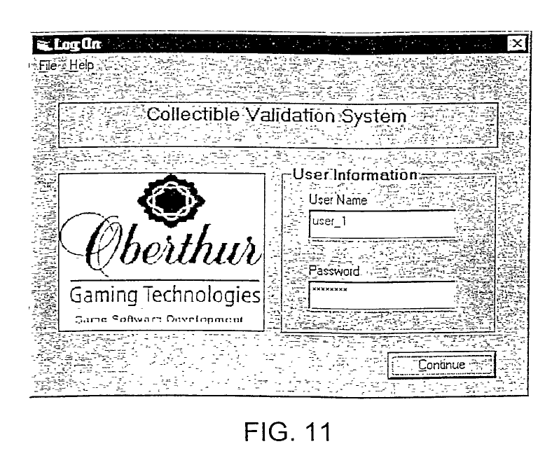

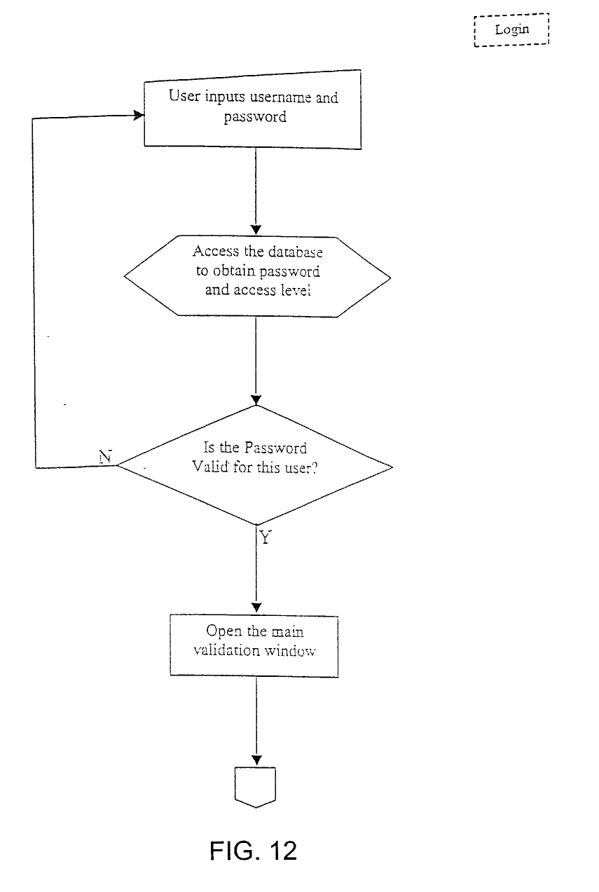

Once the application software is loaded various configuration tasks are generally required (e.g., set up of one or more user names, passwords and associated access privileges). The configuration of application software with names, passwords and associated access privileges is well known to those skilled in the art. FIG. 11 shows an exemplary Login screen from an exemplary CVS in accordance with the invention. FIG. 12 shows an exemplary flow chart outlining the login process. FIG. 12 is self explanatory to one skilled in the art. It is also understood that FIG. 12 is basic in nature and that other program paths can be added without departing from the scope of the invention.

The system preferably assigns a security level to each user. Each level is preferably associated with a specific set of access privileges and areas that accessible for the given level. Tables 9 and 10 below set out exemplary security levels and associated privileges:

TABLE 9

| | | | Change own | Group |
|---|---|---|---|---|
| Level | User Type | Validation | Password | Maintenance |
| 10 | Operator | Yes | Yes | No |
| 20 | Supervisor | Yes | Yes | Yes |
| 30 | Administrator | Yes | Yes | Yes |

TABLE 10

| | | Database | Loading New | Add/Edit |
|---|---|---|---|---|
| Level | User Type | Backup/Restore | Games | Users |
| 10 | Operator | No | No | No |
| 20 | Supervisor | Yes | Yes | No |
| 60 | Administrator | Yes | Yes | Yes |

Preferably, one user per validation center should is designated as an “Administrator” with access level 60. One user per shift should be designated as “Supervisor” with access level 20. All other users (“Operators) should be with access level 10. Upon first logon after the initial installation of the software, the Administrator should set up all users with a temporary password. Each user should change his/her own password upon first logon.

As discussed above, the CVS is operable to validate collectible part(s) or portion(s) of an instant lottery ticket. A “Winning Collectible Set” generally refers a complete collectable set (i.e., two or more collectable parts that make up the set). Continuing with the Monopoly® example from above, an exemplary game includes 10 categories. Eight of the categories are commonly referred to by colors, such as “Red”, “Light Blue”, etc., based on the colors of typical Monopoly® properties. The remaining two categories refer to the Monopoly® railroad, and utilities.

The term “Group” as used herein refers to a set of games that can be validated together. For example, MNN65 and MNN66. Because the tickets of the games within, the same group should be consistent, it is required that games in the same group must have the same structure. However, different groups under the same structure is allowed. For example, MNN94-MNN95 may form another group under the structure of MONOPOLY. Tickets among MNN94 and MNN95 can be put together to form a winning collectable set. But tickets from MNN65 and MNN94 can not form a winning collectable set, even though they are all under the same structures.

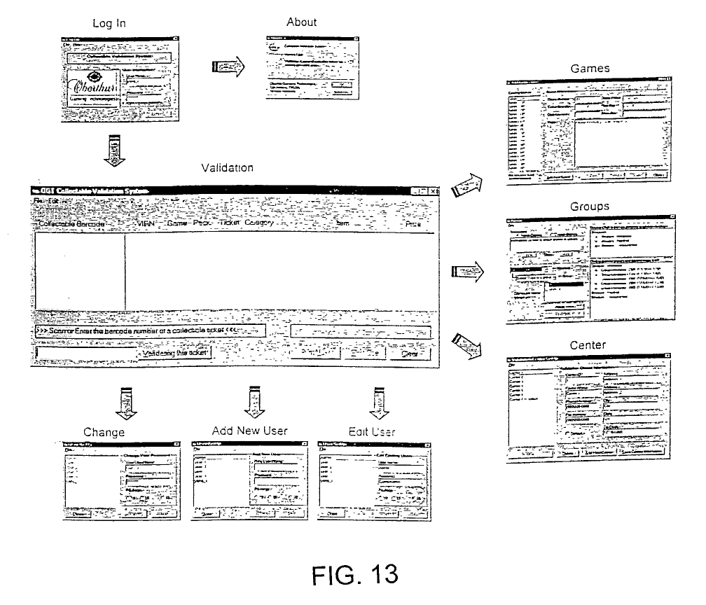

FIG. 13 shows the general relationship between various exemplary CVS system screens. It is understood that layout, configuration and navigation between the various CVS system screens can be varied without departing from the scope of the invention. In this example the Login screen (see FIG. 11) is used to perform user validation through a typical login process. The Validation screen provides an interface to the main ticket validation functionality as well as access to other functions. The Games screen is used to add or delete games. The Group screen is used to form or modify groups of games to be validated together. The Center screen is used to enter or modify regional validation center information. The User screens are used to add new users or modify previously stored user information.

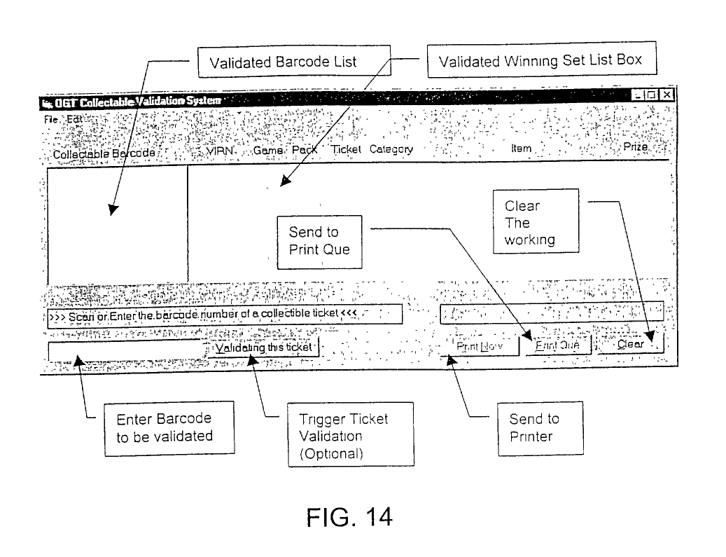

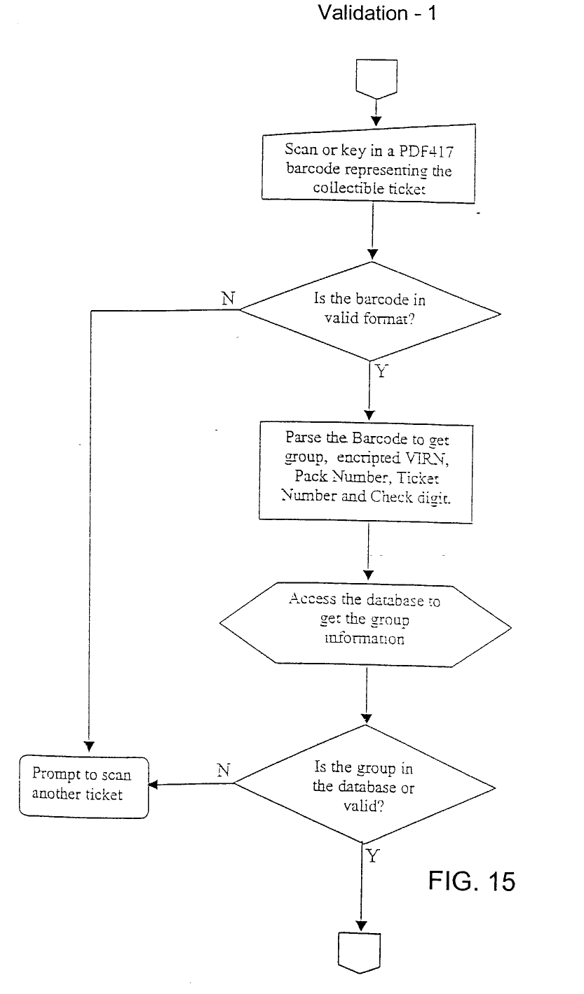

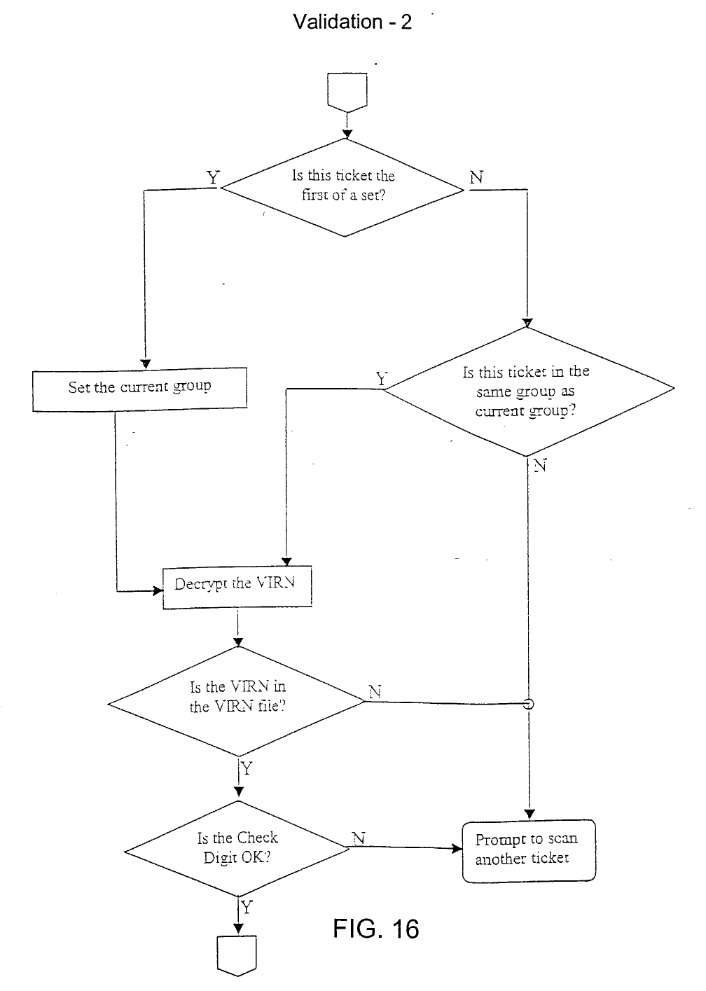

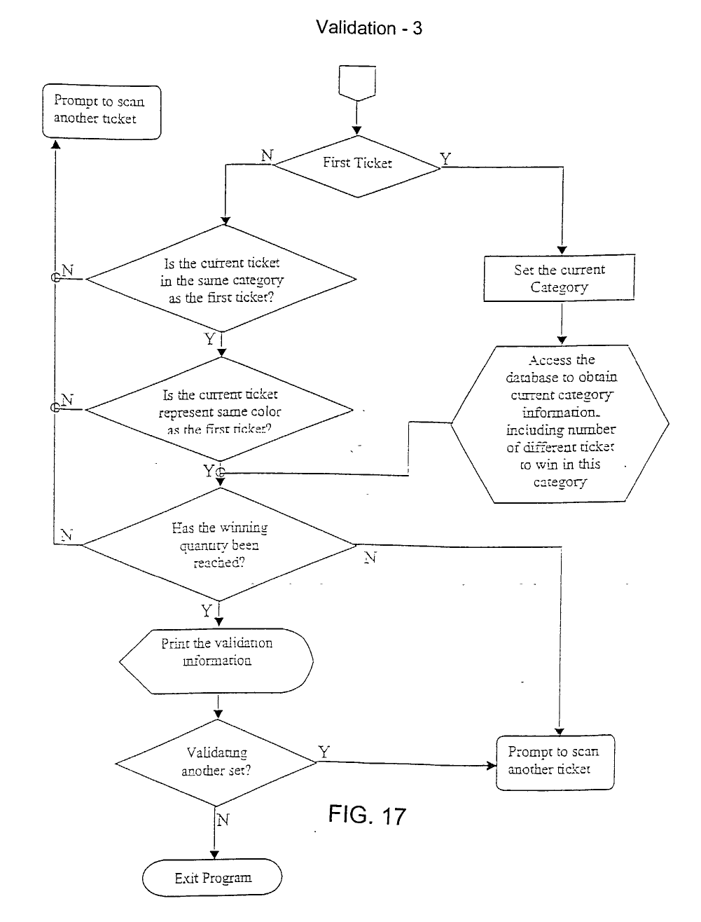

FIG. 14 shows an exemplary validation screen in validating one or more tickets as discussed above. FIGS. 15-17 are flow charts generally outlining the validation process. The validation screen prompts the user to scan the barcode(s) on the collectable tickets or enter the value(s) manually. The system is preferably operable to display the collectable barcode, Game#, Pack#, Virn, Color and Property (as discussed above). The system will then verify whether the collection is valid. Assuming the collection is valid, a message is displayed to the user confirming that the collection is valid. In this event, the prize value is preferably displayed in the Prize field. Then the system then supplies the information to key in the MSL central system (not shown in this example).

Before the validation starts, the collectible tickets should be presorted. Tickets with the same color properties should be placed together in sets. The barcode of a collectible ticket is either scanned via a PDF417 scanner, or keyed in. The scanner preferably emits a brief “beep” sound once the barcode is successfully scanned.

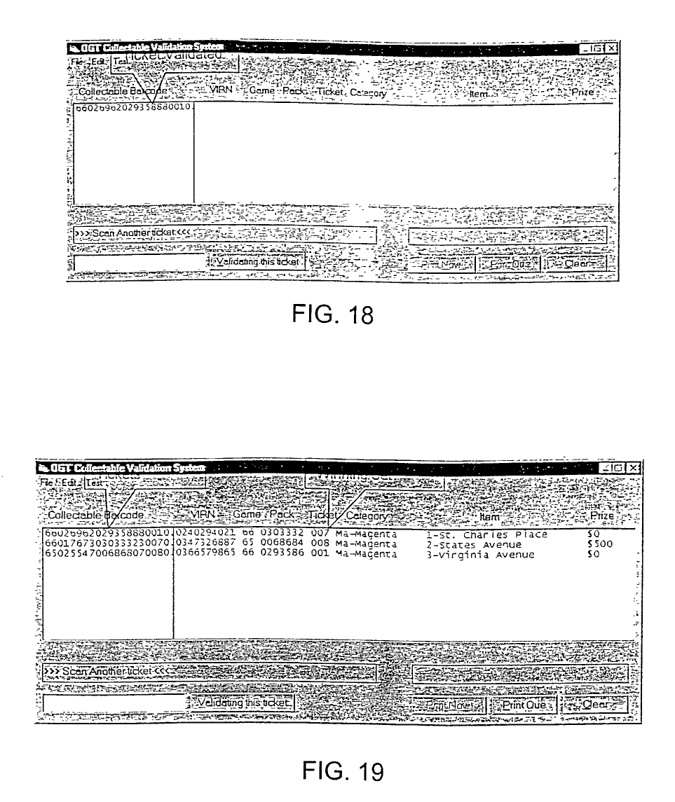

The barcode of the entered ticket appears in the box on the lower left corner of the validation screen (see FIG. 14). Validation is then preferably triggered automatically, once a barcode is entered. Clicking on the “Validating this ticket” button will preferably also trigger validation. The validation process is shown graphically in FIGS. 15-17. Once a ticket is validated, which means it has a valid format, game number, group number, VIRN number and the check digit number, it will appear in the list box under “Collectable Barcode”. See FIG. 18.

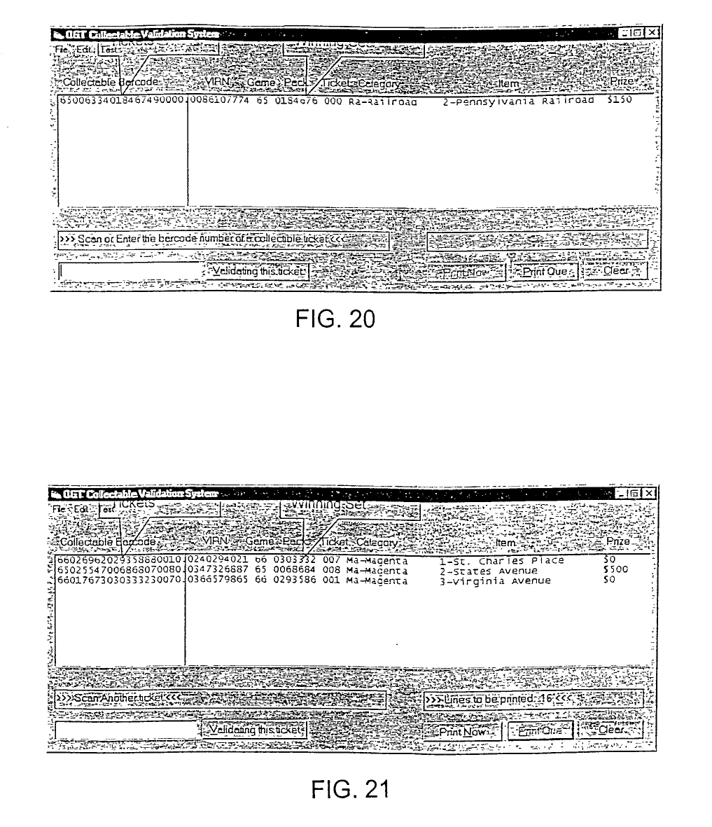

Any subsequent ticket will be checked against the first ticket to see if they belong to the same group of games that can be validated together. If CVS is able to assemble a winning collectable set, the whole winning collectable set will appear in the list box on the right side of the screen. See the FIG. 19 (winning collectable set of three tickets,) and FIG. 20 (winning set of one ticket) below (next page). At this point, the “Print Que” Button is preferably be enabled. Clicking on the Print Que Button will preferably send the winning set information to a print Que where it will be printed automatically (e.g., when a full-page worth of materials (60 lines) are accumulated). If a print out is desired immediately, the “Print Now” button can be selected. See FIG. 21. Once the print-outs are completed, the “Clear” button should be selected to clear the screen before proceeding to validate the nest set of tickets.

Other Database Operations

The system preferably provides other functions for basic administration tasks. For example, the system preferably provides a database backup and restore function. This allows the system administrator to backup the database before it is altered. If for any reason an altered database becomes invalid, the user can always restore the database from the backup.

The system also preferably provides for editing of the database contents. For example: to set up new users or modify user information; or to set up validation center information; or to modify game groups. Many of the basic administration functions such as the addition of users to the system and basic user administration functions are well known to those skilled in the art.

Maintenance of Games and Groups

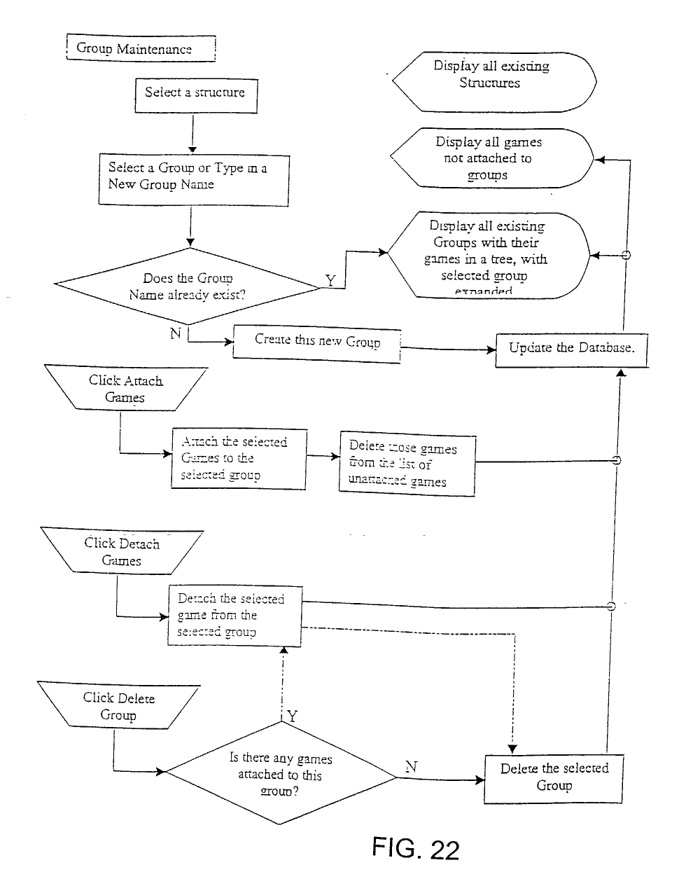

The system preferably provides for maintenance of Games and Groups. From time to time, new game definition may need to be added to an existing group of games so that they can be validated together. New groups of games may need to be formed. One may also need to detach games from existing groups and reattach them to another group. FIG. 22 is a flow chart outlining basic group maintenance tasks.

Loading New Games Manually

The system preferably provides two ways to add new game parameters to the database. The CVS can add a game manually, or the CVS can read the new game parameters from a file of certain format.

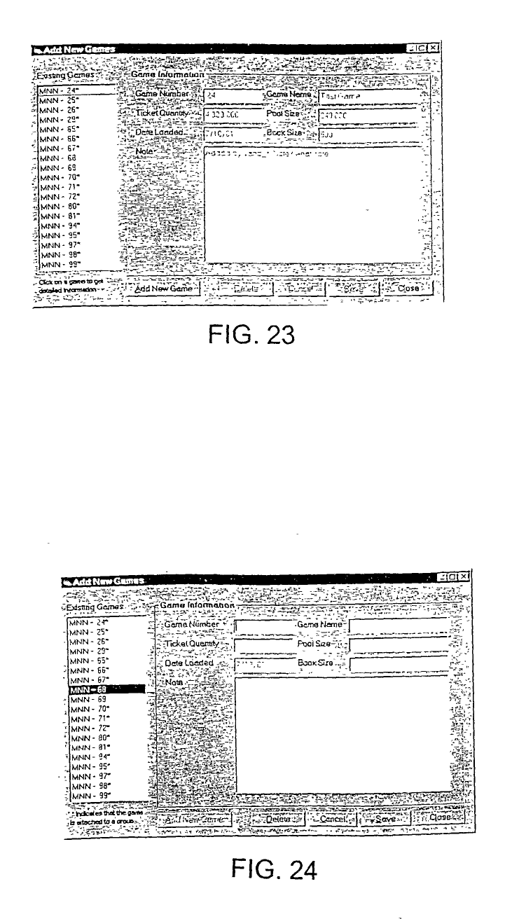

To load a new game manually, the user or administrator preferably selects the appropriate menu (not shown). This leads to an “add new games” screen. See FIG. 23. The listbox on the left side of the screen shows existing games. The “*” indicates that game is attached to a group. If one clicks on one of the game listed, the game information will appear in the frame on the right side of the screen. If a game not attached to a group is clicked, the “Delete” button will be enabled, thereby allowing the user or administrator to delete that game from the database. Once a game is deleted from a database, its information is no longer kept anywhere in the database. In this example, the only way to restore a deleted game is to re-add it in as a new game.

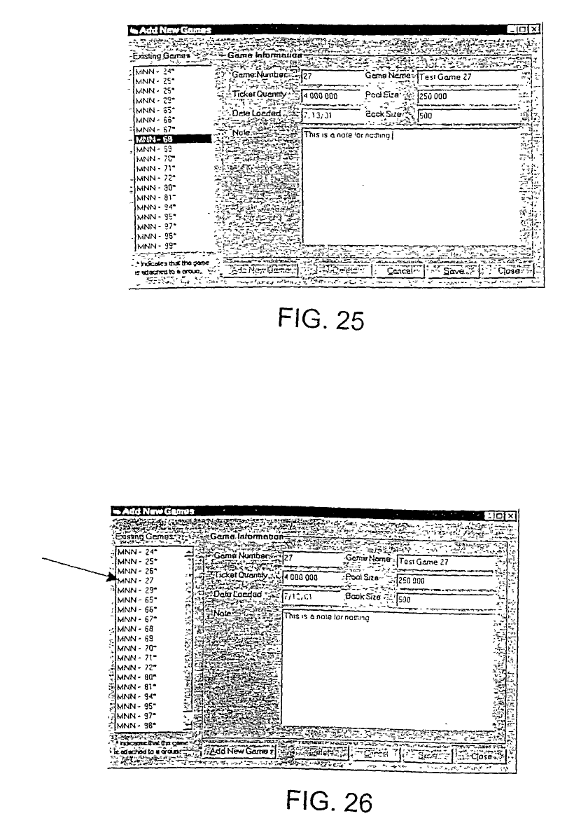

To add a new game to the database, click on the button “Add New Game”. The text boxes in the frame “Game Information” will be cleared. See FIG. 24. The user or administrator then fills in all boxes with the exception of the “Date Loaded” box, which is preferably filled automatically with the system date. Pressing the “TAB” key or the “ENTER” key preferably takes the user to the next box. A user can optionally supply a note about this game. All game related information, along with the user who added this same, is then saved to the database. Once all boxes are filled, the user then presses the “Save” button to save the information to the database, or “Cancel” button to cancel this action. See FIG. 25.

Once the new games is successfully saved, it will appear in the “Exiting Games” Listbox. See FIG. 26. The user can then click on the newly added game to verify that all information is correct. If some information is not correct, the user can delete the game and repeat the process again. The process can also be repeated until all new games are added.

Loading New Games Automatically

To make the task of loading new games even easier, the system preferably provides for automatic loading of games. This is accomplished via a file that holds all necessary information about the new games to be added to the database. The CVS can preferably read the file (e.g., from a disk) and perform the entire task of loading new games automatically.

An exemplary file format is would be a flat ASCII file in the following format where:

Each line represents one game

Each game is composed of the following fields, separated by comma's:

“Game Number, Game Name, Ticket Quantity, Pool size, book size, note”

For example:

File “newgame.txt”:

98, Test Game 1 for Reading from File, 5000000,240000,500, This is a note

99, Test Game 2 for Reading from File, 5000000.240000,500, This is a note

97, Test Game 3 for Reading from File, 5000000,240000,500, This is a note

The autoload file (e.g., newgame.txt) is preferably then selected from an appropriate menu and the data is automatically loaded into the system.

Maintenance of Groups

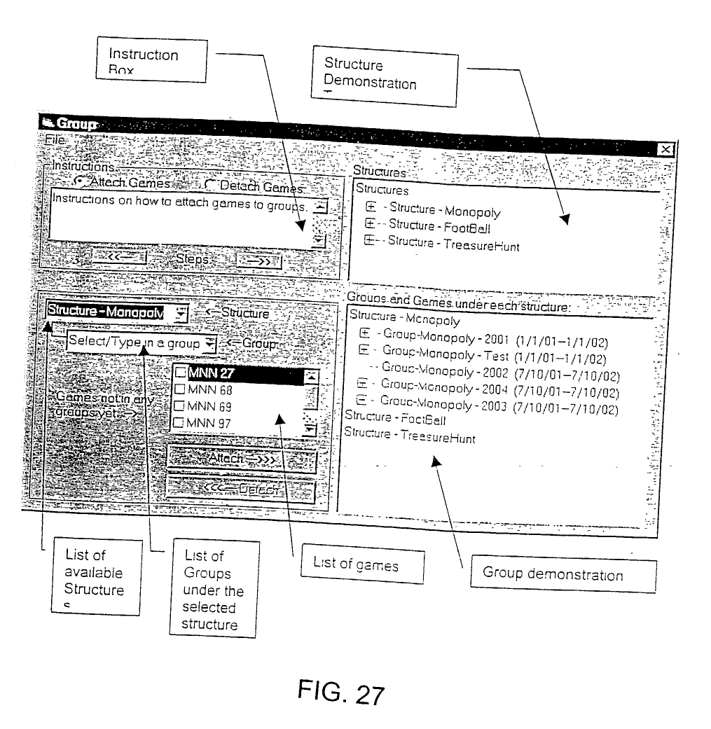

A Group Maintenance Screen is shown in FIG. 27. Preferably, by floating the mouse over any boxes or buttons, brief explanations about the functions of that object are brought up.

Preferably, the following tasks that can be carried out via this screen:

Create new groups

Delete groups

Attach games to groups

Detach games from groups

Upon loading, the “Structure Demonstration Tree” preferably holds the structure definitions. Clicking on the [+] or [−] sign expands or collapse the branches thereby showing the associated tree structure.

The “Group Demonstration Tree” preferably holds all groups under currently available structures with the branches of the first structure expanded. On the left side of the screen, the “Instruction” box provides instructions on how to perform attaching/detaching games depending on the selection made by the user.

The “Structure List Box” preferably lists all currently available structures with the first one selected. The “Group List Box” preferably lists all groups under the structure selected in the Structure List Box. The “Game List Box” preferably lists all games that currently are not attached to any groups

The contents in the Structure List, Group list and the Group Tree are preferably synchronized. For example, changing the selection in the “Structure List Box” preferably causes the content of the “Group List Box” to be changed accordingly and the corresponding structure branch in the group tree structure to be expanded. Clicking on a game in the Group Tree preferably causes the structure and group to which this belongs to be selected in the Structure List and Group List Boxes, if they are not already selected. This will generally ensure the integrity of the information.

Creating a New Group

Creating a new group is a straight forward process. The user or administrator selects a structure by either selecting it from the Structure List Box, or click the structure on the Group Tree. The name of the new group to be created is entered into the Group List Box. If this name is one of the existing group, the corresponding group will be selected and expanded in the Group Tree box. If the name is new, a confirmation message preferably appears prompting the user to confirm that a new group should be created.

Once the group is created, a screen with two calendars preferably is displayed to the user. This will allow the user to choose the beginning date and the ending date of this group (e.g., one year). The information is preferably then carried back to the Group screen. Upon returning to the Group screen, the new group will be added to the database and the Group Tree will be updated.

Deletion of a Group:

Deletion of a group is also straight forward. The user or administrator clicks on the group to be deleted on the Group Tree, preferably a command button at the lower edge of the screen will be enabled with the caption “<<<—Delete Group”. Clicking on the Delete Group Button preferably brings up a confirmation message prompting the user to confirm that they wish to delete the selected group. Upon confirmation, the group is preferably deleted from the database.

If there are any games attached to the group, the games will preferably be detached from the group but not deleted from the database. In this event, the games preferably appear in the Game List Box and can be attached to other groups. The tickets belonging to unattached dames will not be validated. But the existence of games not belonging to any group preferably will not affect the validation of tickets of other games that do belong, to valid groups.

Attaching Games to a Group

Attaching games to a group proceeds as follows. The user or administrator selects one or more games by clicking on the check box in front of each game in the Game List Box. Then the user clicks on the “Attach” button. If there are more games to be detached, the steps outlined above can be repeated.

Detaching a Game from a Group

Detaching games from a group proceeds as follows. The user or administrator selects the game to be detached, a group branch can be expanded if needed. Then the user clicks on the “Detach” button. If there are more than one game to be detached, the steps outlined above can be repeated.

Validation Center Information Screen Components

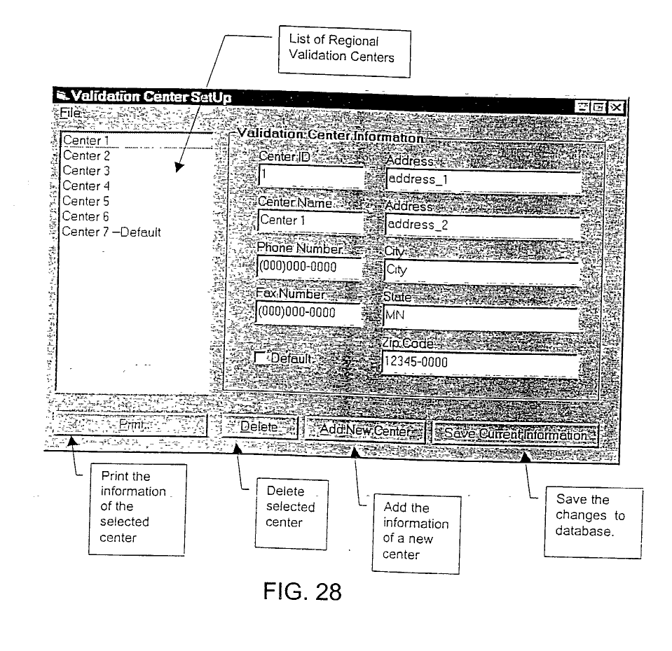

FIG. 28 is an exemplary Validation Center screen. Validation Center Information maintenance proceeds as follow. The user or administrator selects the Validation Center area from the appropriate menu. The “Default center” is the preferably the Regional Validation Center at which the user is operating. The default center is preferably included in the validation printout along with the user name.

Selection of a New Default Center

Selection of a new default center is accomplished by clicking on the center to be set, checking the “Default” box and click the “Save” button. The selected center should be marked as “default” now.

Creation of a New Center

Creation of a new center is accomplished by clicking on “Add a New Center”, all text boxes should be cleared automatically. All of the relevant information is entered (e.g., center ID, center name, address, phone number and the like). Preferably, the fax number and Address Line 2 are optional. Preferably, all other information is mandatory. The information is saved by clicking on the “Save” button. If all fields passes validation, the information will be saved to the database, otherwise, the system will prompt the user to re-enter the information and save again.

Editing Information Relating to Existing Centers

Editing information relating to an existing center is straight forward. The user simply clicks the center to be edited. The desired information is edited and then the save button is clicked to save the changes to the database.

While this invention has been described with an emphasis upon preferred embodiments, it will be obvious to those of ordinary skill in the art that variations in the preferred devices and methods may be used and that it is intended that the invention may be practiced otherwise than as specifically described herein.

What is claimed is:

1. A method for validating a set of collectible lottery tickets comprising:
providing at least two lottery tickets each including a collectable part having associated verification indicia;
providing a retailer computer terminal at a retailer location, the retailer computer terminal being operable to at least temporarily store the verification indicia from the collectible parts;
communicating the verification indicia from the retailer computer terminal to a computerized central validation system remote from the retailer location, the computerized central validation system including a database containing validation data;
performing validation of the at least two collectible parts to determine whether the at least two collectible parts are a winning collectable set based on the verification indicia and the validation data thereby generating validation results; and then
communicating the validation results to the retailer computer terminal.

2. The method of claim 1 wherein a winning collectable set requires a specific combination of two collectable parts.

3. The method of claim 1 wherein a winning collectable set requires a specific combination of three collectable parts.

4. The method of claim 1 wherein the associated verification indicia is a bar code.

5. The method of claim 4 wherein the retailer computer terminal includes at least one bar code scanner operable to read the bar codes associated with the collectable parts.

6. The method of claim 1 wherein the collectible part has an associated game number, group number, VIRN and check digit number and wherein the validation process includes verifying that the collectible portions have the proper game number, group number, VIRN and check digit number.

7. The method of claim 1 wherein each lottery ticket has an instant win part and a collectable part.

8. The method of claim 7 wherein the instant win part and collectable part each have an associated ticket number.

9. The method of claim 8 wherein the collectable part ticket number is an integer multiple of the instant win part ticket number.

10. A system for validating a set of collectible lottery tickets comprising:
at least two lottery tickets each including a collectable part having associated verification indicia;
a retailer computer terminal located at a retailer location, wherein the retailer computer terminal is operable to at least temporarily store the verification indicia from the collectible parts;
a computerized central validation system located remotely from the retailer location the computerized central validation system including a database containing validation data;
wherein the retailer computer terminal is operable to communicate the verification indicia from the retailer computer terminal to the central validation system, and the central validation system is operable to perform validation of the at least two collectible parts to determine whether the at least two collectible parts are a winning collectable set based on the verification indicia and the validation data thereby generating validation results, and wherein the central validation system is operable to communicate the validation results to the retailer computer terminal.

11. The system of claim 10 wherein a winning collectable set requires a specific combination of two collectable parts.

12. The system of claim 10 wherein a winning collectable set requires a specific combination of three collectable parts.

13. The system of claim 10 wherein the associated verification indicia is a bar code.

14. The system of claim 13 wherein the retailer computer terminal includes at least one bar code scanner operable to read the bar codes associated with the collectable parts.

15. The system of claim 10 wherein the collectible part has an associated game number, group number, VIRN and check digit number and wherein the validation process includes verifying that the collectible portions have the proper game number, group number, VIRN and check digit number.

16. The system of claim 10 wherein each lottery ticket has an instant win part and a collectable part.

17. The system of claim 16 wherein the instant win part and collectable part each have an associated ticket number.

18. The system of claim 17 wherein the collectable part ticket number is an integer multiple of the instant win part ticket number.

19. A system for validating a set of collectible lottery tickets comprising:
at least two lottery tickets each including a collectable part having associated verification indicia;
a retailer computer terminal means located at a retailer location, wherein the retailer computer terminal is operable to at least temporarily store the verification indicia from the collectible parts;
a computerized central validation means located remote from the retailer location the computerized central validation means including a database containing validation data;
wherein the retailer computer terminal means is operable to communicate the verification indicia from the retailer computer terminal means to the central validation means, and the central validation means is operable to perform validation of the at least two collectible parts to determine whether the at least two collectible parts are a winning collectable set based on the verification indicia and the validation data thereby generating validation results, and wherein the central validation means is operable to communicate the validation results to the retailer computer terminal means.

20. A method for validating a set of collectible lottery tickets from either a single game or different games that are interrelated for purposes of providing a winning combination, said method comprising the steps of:
providing a retailer with a computer terminal including scanning means for scanning coded information on individual lottery tickets;
establishing a computerized central validation system remote from the retailer, said system including a database containing a coded listing of winning lottery tickets and/or a collection of lottery tickets the combination of which if valid a represent a winning combination;
establishing a communication link between said retailer and said central validation system, for permitting said retailer to transmit scanned ticket data thereto for validation;
programming said validation system to compare scanned ticket data with the winners list in its database, and transmit the results back to said retailer.
